(19) United States
(12) Patent Application Publication
(10) Pub. No.: US 2006/0131817 A1
(43) Pub. Date: Jun. 22, 2006

(54) Gasket assembly for joints experiencing thermally induced movement

(76) Inventor: Colin J. Kerelchuk, Peoria, IL (US)

Correspondence Address: CATERPILLAR INC.;100 N.E. ADAMS STREET, PATENT DEPT., PEORIA, IL, 616296490, US

(21) Appl. No.: 11/015,516

(22) Filed: Dec. 17, 2004

(51) Int. Cl. F02F 11/00

(52) U.S. Cl. 277/592

(57) ABSTRACT

A gasket assembly for joints experiencing thermally induced movement. The gasket assembly may include a first layer, a second layer having a first portion in contact with a portion of the first layer and a second portion extending beyond contact with the first layer, and a third layer, the first portion of the second layer being in contact between the portion of the first layer and a like portion of the third layer. The gasket assembly is arranged between first and second components to accommodate thermal expansion from the first and second components.

### TECHNICAL FIELD

This invention relates to a gasket assembly and more particularly to a gasket assembly for accommodating thermally induced gasket movement in joints of an internal combustion engine.

### BACKGROUND

Gaskets have been widely used between joints in internal combustion engines to achieve pressure tight seals. During normal operation of the engine, cyclic temperature changes can cause thermal expansion and contraction of various components at varying rates. For example, the connection between an exhaust manifold and a turbocharger generally exhibits an increased amount of thermal expansion in the divider wall between the two openings versus the amount of expansion in the surrounding walls. The increased thermal expansion may be due to the limited divider wall thickness and limited material in which to dissipate heat thereby causing the divider wall to heat up more quickly and to higher temperatures than outlying areas. The relative movement of the divider walls between the exhaust manifold and the turbocharger, if not absorbed by the gasket positioned between the two components, can cause the exhaust manifold or the manifold gasket to crack or may damage the connecting bolts used for connecting the exhaust manifold to the turbocharger.

Furthermore, an exhaust manifold flange must also have the structural integrity to support a rigid connection with a turbocharger. This rigid connection reduces vibrations between the turbocharger and the flange and ensures that a good seal is maintained between the turbocharger and flange. In addition, the connection between the exhaust manifold flange and the turbocharger is typically the only rigid connection between the turbocharger and the engine. All other connections between the turbocharger and the engine are flexible so that no significant forces will be applied to the turbocharger from thermal expansion of the turbocharger, the engine or the connections. Therefore, an exhaust manifold flange must be capable of supporting the weight of the turbocharger and other forces introduced by the turbocharger on the engine, e.g. vibrations, motion induced torque, and the like.

Some prior art gaskets have recognized the importance of compensating for the relative movement between the exhaust manifold and the turbocharger. Stainless steel gaskets with a soft inner material, such as graphite, have been used in the exhaust manifold connection, but have failed due to the expansion of the divider walls in the direction of the opposing divider wall and due to the weight of the turbocharger. Solid stainless steel gaskets have also been used to support the weight of the turbocharger, but due to thermal expansion of the divider walls in the direction of the opposing divider wall, has led to cracking of the connecting bolts. Stainless steel gaskets without a divider wall are being used in various applications. However, this may lead to cross-over flow of the exhaust gases leading to a potential loss in energy transfer from the engine to the turbocharger as well as erosion of the divider walls of the exhaust manifold and the turbocharger due to the increased temperature of exhaust gases produced by today's internal combustion engines. Therefore, a gasket assembly is needed that may be capable of providing a dual sealing function, handling thermal expansion of the sealed components, and providing a rigid joint.

The present disclosure is directed to overcoming one or more of the problems as set forth above.

### SUMMARY OF THE INVENTION

It is to be understood that both the foregoing general description and the following detailed description are exemplary and explanatory only and are not restrictive of the invention as claimed.

One aspect of the present disclosure is directed to a gasket assembly for providing a seal between a first component, and a second component secured to the first component. The gasket assembly comprises a first layer and a second layer. The second layer has a first portion in contact with a portion of the first layer and a second portion extending beyond contact with the first layer.

Another aspect of the present disclosure is directed to a method for manufacturing a gasket assembly for use between a first component and a second component. The method comprises forming a first layer, forming a second layer having a first portion contacting a portion of the first layer and a second portion extending beyond contact with the first layer, and attaching the second layer to the first layer.

Yet another aspect of the present disclosure is directed to a method for providing a seal between a first component and a second component. This method comprises arranging a gasket assembly between the first component and the second component and securing the first component to the second component. The gasket assembly has a first layer and a second layer, the second layer having a first portion in contact with a portion of the first layer and a second portion extending beyond contact with the first layer.

### BRIEF DESCRIPTION OF THE DRAWINGS

FIG. 1 is a partial exploded view of the assembly of an exhaust manifold and a turbocharger with a gasket assembly therebetween according to one embodiment of the present disclosure;

FIG. 2 is an elevational view of the gasket assembly according to one embodiment of the present disclosure;

FIG. 3 is a partial exploded view of the gasket assembly according to one embodiment of the present disclosure; and

FIG. 4 is a sectional view of the gasket assembly according to one embodiment of the present disclosure.

### DETAILED DESCRIPTION

Reference will now be made in detail to embodiments of the invention, examples of which are illustrated in the accompanying drawings. Whenever possible, the same reference numbers will be used throughout the drawings to refer to the same or like parts.

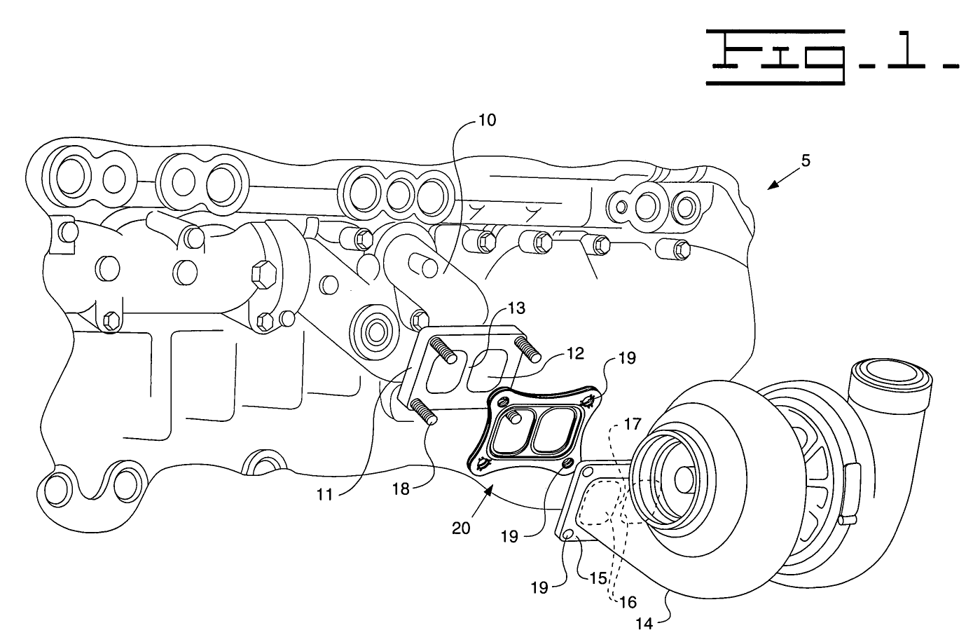

FIG. 1 shows a partial exploded view of the assembly of an exhaust manifold and a turbocharger with a gasket assembly 20 therebetween according to one embodiment of the present disclosure. An engine 5 includes a first component 10 being an exhaust manifold, a second component 14 being a turbocharger, and a gasket assembly 20 disposed therebetween. Although the first and second components 10, 14 are shown here as being an exhaust manifold and a turbocharger, the first and second components 10, 14 may be any of a number of components where a pressure tight seal may be useful or a portion of the joint may experience thermally induced movement.

As shown in FIG. 1, the gasket assembly 20 is disposed between a first component flange 11 and a second component flange 15. The first and second component flanges 11, 15 may generally be flat machined surfaces that correspond to one another such that connecting bolts 18 may operably connect the first component 10, the gasket assembly 20, and the second component 14 via through-holes 19 for the connecting bolts 18 that may located in each of the first and second components 10, 14 and the gasket assembly 20. The first component flange 11 has first component openings 12 and a divider wall 13 that correspond to second component openings 16 and associated divider wall 17 in the second component flange 15. While it is shown in FIG. 1 that the first component 10 has two openings 12 and a divider wall 13, gasket assembly 20 may be configured to accommodate a single opening as well as multiple openings with multiple divider walls between the openings.

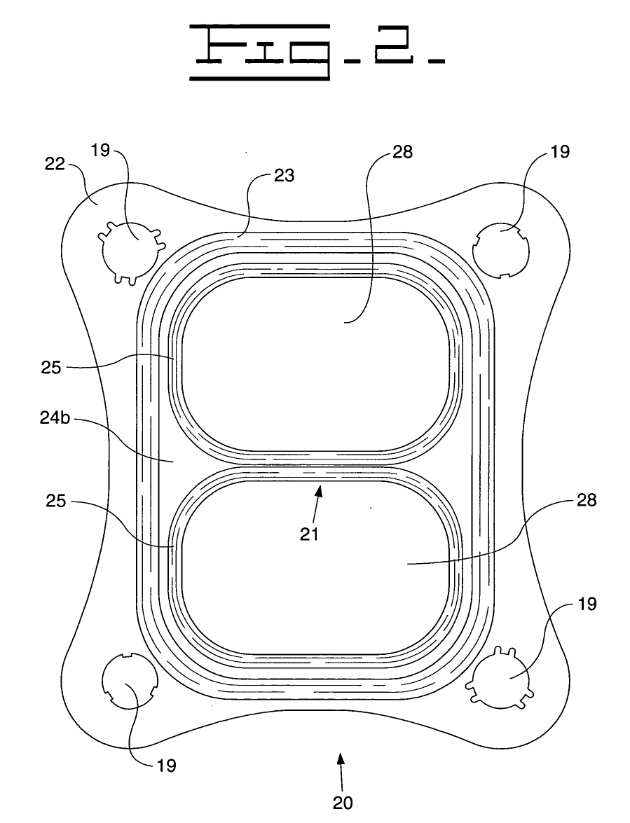

FIG. 2 is an elevational view of the gasket assembly 20 according to one embodiment of the present disclosure. Referring to FIG. 2, the gasket assembly 20 includes a first layer 22 and a second layer 24, the second layer 24 partially overlayed by the first layer 22. The elevational view of the gasket assembly 20 shows a second portion 24B of the second layer 24 that extends beyond contact with the first layer 22. The second portion 24B of the second layer 24 may extend about each of one or more openings 28, with multiple openings being separated by a gasket assembly divider wall 21. The second layer 24 has a first portion 24A that is in contact with the first layer 22. The first layer 22 may have an embossment 23 in the portion of the first layer 22 closest to the gasket assembly openings 28. The second layer 24 may have embossments 25 surrounding each of the one or more gasket assembly openings 28.

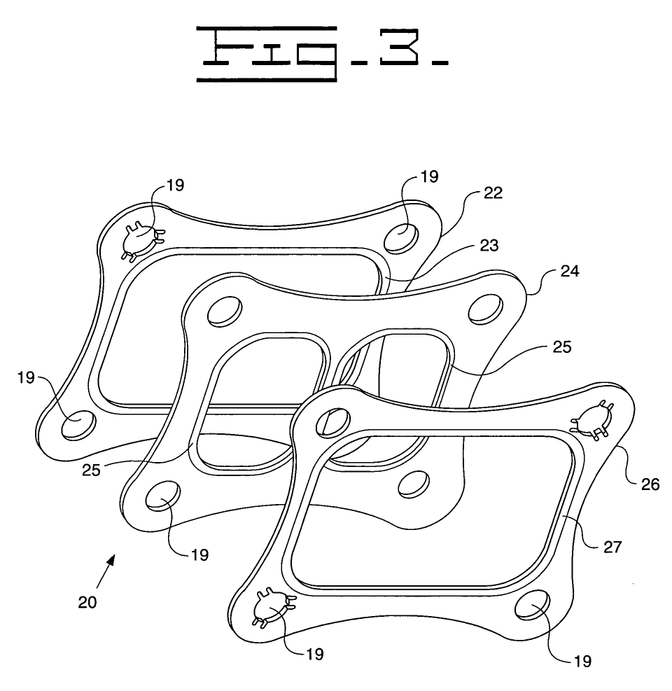

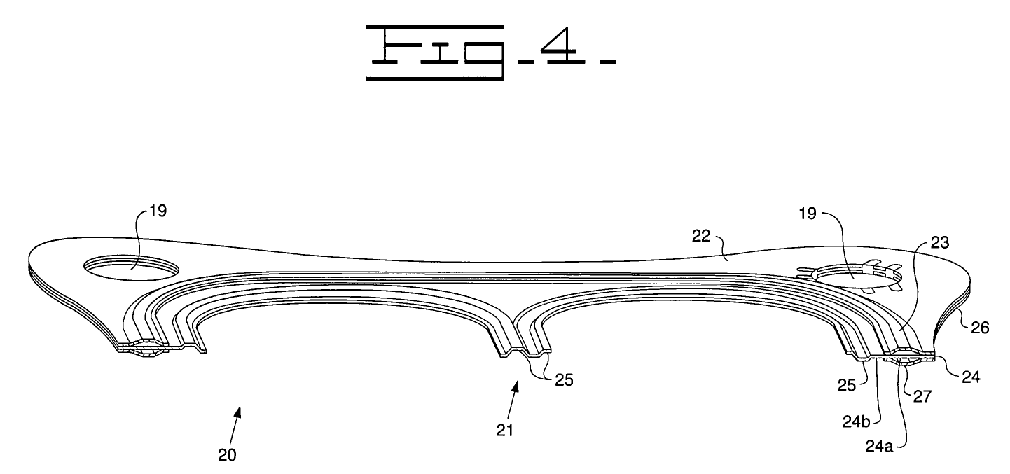

FIG. 3 is a partial exploded view of the gasket assembly 20 according to one embodiment of the present disclosure. Referring to FIG. 3, the gasket assembly 20 shows the first layer 22, the second layer 24, and a third layer 26. FIG. 4 is a sectional view of the gasket assembly 20 according to one embodiment of the present disclosure. FIG. 4 shows the first portion 24A of the second layer 24 being in contact between a portion of the first layer 22 and a like portion of the third layer 26. While FIG. 3 and FIG. 4 show the gasket assembly 20 having first, second, and third layers 22, 24, 26, the gasket assembly may also have only a first and second layer 22, 24 or may include additional layers to the first, second, and third layers 22, 24, 26.

The first, second, and third layers 22, 24, 26 may have respective embossments 23, 25, 27 at certain locations along each of the first, second, and third layers 22, 24, 26. Generally, the embossments, 23, 25, 27 may be located near the first and second component openings 12, 16 but may or may not be in each of the first, second, and third layers 22, 24, 26. The second layer, as shown, may have embossments 25 to surround each gasket assembly opening 28 that may be formed in gasket assembly 20 in accordance with the first and second component openings 12, 16, but may have more or less gasket assembly openings 28 and embossments 25 depending on the number of first and second component openings 12, 16.

The first, second, and third layers 22, 24, 26 may generally be comprised of metallic materials, such as stainless steel, but may comprise other materials that also may be capable of maintaining a sealing condition in various environments and configurations of the gasket assembly 20. Generally, while the first and third layers 22, 26 may be comprised of stainless steel, the second layer 24 may be comprised of an alloy with greater high temperature strength than stainless steel, such as various waspaloy materials, inconel alloys, and the like. The use of materials with high temperature strength may depend upon the application and the thermal expansion that may result in areas of the first and second components 10, 14 around the first and second component openings 12, 16.

### INDUSTRIAL APPLICABILITY

The gasket assembly 20 is manufactured to provide a pressure tight seal between a first component 10 and a second component 14. The gasket assembly 20 may compensate for thermally induced movement between the first component 10 and the second component 14 that may occur to a greater degree in the area of the first and second components 10, 14 surrounding one or more openings 12, 16 which may include divider walls 13, 17 between openings 12, 16. To accomplish this, a gasket assembly 20 may be manufactured for use between a first and second component 10, 14. This method may comprise forming a first layer 22 having a shape indicative of the first and second component flanges 11, 15 and an opening indicative of the first and second component openings 12, 16, forming a second layer 24 having a first portion 24A contacting a portion of the first layer 22 and a second portion 24B extending beyond contact with the first layer 22 and indicative of each of the first and second component openings 12, 16 and divider walls 13, 17, and attaching the first layer 22 to the second layer 24. In additional embodiments of the present disclosure, the gasket assembly 20 further includes forming a third layer 26, the first portion of the second layer 24A being in contact between the portion of the first layer 22 and a like portion of the third layer 26, and attaching the third layer 26 to the second and first layers 24, 22. Further embodiments may include forming embossments 25 in the second layer 24 and forming embossments 23, 27 in the respective first and third layers 22, 26.

To provide a seal between the first and second components 10, 14, the gasket assembly 20 may be arranged between the first and second components 10, 14 before securing the first and second components 10, 14 to one another. As the first and second components 10, 14 are secured to each other, a first seal may be created between a combination of the first layer 22, the first portion 24A of the second layer 24, and the third layer 26. First and third layer embossments 23, 27 may provide additional sealing force against the first and second components 10, 14 by resisting compression and exerting pressure on the first and second component flanges 11, 15 as the first and second components 10, 14 are secured to one another.

Although a second seal may be created between the first and second components 10, 14 by the second portion 24B of the second layer 24, the second portion 24B of the second layer 24 may also be capable of accepting the thermal expansion that may occur in the areas around the first and second component openings 12, 16 and divider walls 13, 17. Second layer embossments 25 may be configured to further compress and expand as the first and second components 10, 14 thermally expand and retract. As thermal expansion occurs between a first and second component 10, 14, such as the case between an exhaust manifold and a turbocharger when an engine 5 is started and operated, the areas around the first and second component openings 12, 16 and, more specifically, the divider walls 13, 17 expand toward one another and compress the gasket assembly divider wall 21. It is likely that the expansion in the divider walls 13, 17 will be greater than in other areas around the first and second component openings 12, 16 because the divider walls 13, 17 have less material in which to dissipate the heat generated from the engine exhaust. As such, the divider walls 13, 17 will heat up more rapidly and to higher temperatures than in the other areas surrounding first and second component openings 12, 16. The second portion 24B of the second layer 24 and the second layer embossments 25 may be capable of accepting the expansion that may occur between the first and second component divider walls 13, 17. Selection of materials with high temperature strength for use in the second layer 24 may allow the second layer 24 to last longer than would regular stainless steel materials in high temperature applications and better maintain a seal at the higher temperatures that may be generated in engine applications.

In view of the above, a gasket assembly 20 is disclosed that may be capable of handling thermal expansion of sealed components, providing a rigid joint, providing a dual sealing function, limiting stress transmitted to connecting, and providing other advantages disclosed herein. It will be apparent to those skilled in the art that various modifications and variations can be made in the system and method of the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1. A gasket assembly for providing a seal between a first component, and a second component secured to the first component, comprising:
a first layer;
a second layer having a first portion in contact with a portion of the first layer and a second portion extending beyond contact with the first layer; and
a third layer, the second layer being in contact with and between the first and third layers;
wherein the second portion of the second layer contacts a portion of the first component;
wherein the second portion of the second layer contacts a portion of the second component;
the second layer has greater high temperature strength than the first and third layers.

2. The gasket assembly as set forth in claim 1, wherein the first portion of the second layer is in contact between the portion of the first layer and a like portion of the third layer.

3. The gasket assembly as set forth in claim 2, wherein the second portion of the second layer extends beyond contact with the first and third layers.

4. The gasket assembly as set forth in claim 3, wherein the second layer includes an embossment in the second portion.

5. The gasket assembly as set forth in claim 4, wherein each of the first and third layers include an embossment configured to be in contact with respective first and second components.

6. The gasket assembly as set forth in claim 5, wherein the embossments in the first and third layers compress when installed between the first component and the second component; and
wherein the embossment in the second layer is configured to compress and expand as the first and second components expand and retract.

7. The gasket assembly as set forth in claim 6, wherein at least one of the first, second, and third layers are metallic.

8. The gasket assembly as set forth in claim 7, wherein the first and third layers are stainless steel.

9. (canceled)

10. The gasket assembly as set forth in claim 6, wherein the second portion of the second layer is configured to extend around each of a plurality of openings in the first and second components.

11. The gasket assembly as set forth in claim 4, wherein the embossment in the second portion is configured to extend around each of the plurality of openings.

12. A method for manufacturing a gasket assembly for use between a first component and a second component, comprising:
forming a first layer;
forming a second layer having a first portion contacting a portion of the first layer and a second portion extending beyond contact with the first layer; ELI
attaching the second layer to the first layer;
forming a third layer; and
attaching the third layer to the second layer, the second layer being in contact with and between the first and third layers;
wherein the second portion of the second layer contacts a portion of the first component;
wherein the second portion of the second layer contacts a portion of the second component;
the second layer is formed from a material having greater high temperature strength than the first and third layers.

13. The method for manufacturing a gasket assembly as set forth in claim 12, wherein:
the first portion of the second layer is in contact between the portion of the first layer and a like portion of the third layer, and
the second portion of the second layer extends beyond contact with the first and third layers;

14. The method for manufacturing a gasket assembly as set forth in claim 13, further including:
forming an embossment in the second portion of the second layer.

15. The method for manufacturing a gasket assembly as set forth in claim 14, further including:
forming an embossment in each of the first and third layers configured to be in contact with respective first and second components.

16. The method for manufacturing a gasket assembly as set forth in claim 15, wherein at least one of the first, second and third layers are metallic.

17. The method for manufacturing a gasket assembly as set forth in claim 16, wherein the first and third layers are formed from stainless steel.

18. (canceled)

19. A method for providing a seal between a first component and a second component, comprising:
arranging a gasket assembly between the first component and the second component, the gasket assembly having a first layer, a second layer, and a third layer, the second layer having a first portion in contact with a portion of the first layer and a second portion extending beyond contact with the first layer, the second layer being in contact with and between the first and third layers; and
securing the first component to the second component;
wherein the second portion of the second layer contacts a portion of the first component;
wherein the second portion of the second layer contacts a portion of the second component;
the second portion of the second layer contacting the first component and the second component is a single layer; and
the second layer is formed from a material having greater high temperature strength than the first and third layers.

20. The method for providing a seal as set forth in claim 19, wherein:
the first portion of the second layer is in contact between the portion of the first layer and a like portion of the third layer, and
the second portion of the second layer extends beyond contact with the first and third layers.

21. The method for providing a seal as set forth in claim 20, wherein securing the first component to the second component includes the steps of:
creating a first seal between the first and second components by a combination of the first layer, the first portion of the second layer, and the third layer; and
creating a second seal between the first and second components by the second portion of the second layer.

22. The method for providing a seal as set forth in claim 21, wherein creating first and second seals further includes the steps of:
compressing an embossment in the second portion of the second layer.

23. The method for providing a seal as set forth in claim 22, wherein creating first and second seals further includes the steps of:
compressing an embossment in each of the first and third layers configured to be in contact with respective first and second components.

24. The method for providing a seal as set forth in claim 23, wherein the embossments in the first and third layers compress when installed between the first component and the second component; and
wherein the embossment in the second layer is configured to compress and expand as the first and second components expand and retract.

25. The gasket assembly of claim 1, wherein the second layer has uniform material properties throughout the second layer.
